(19) United States
(12) Patent Application Publication
(10) Pub. No.: US 2026/0042105 A1
(43) Pub. Date: Feb. 12, 2026

(54) SHOWER HEAD SYSTEM FOR LOWERING PH OF WATER

(71) Applicant: James Lapinsky, Malibu, CA (US)

(72) Inventor: James Lapinsky, Malibu, CA (US)

(21) Appl. No.: 19/272,101

(22) Filed: Jul. 17, 2025

Related U.S. Application Data
(60) Provisional application No. 63/679,946, filed on Aug. 6, 2024.
(60) Provisional application No. 63/703,929, filed on Oct. 5, 2024.

(51) Int. Cl. B05B 1/18; B05B 15/40; E03C 1/046

(52) U.S. Cl. CPC B05B 1/18; B05B 15/40; E03C 1/046

(57) ABSTRACT

The present invention discloses a shower head system. The system comprises a shower head housing comprising a proximal end and a distal end. The proximal end comprises one or more water inlet apertures and the distal end comprises one or more water outlet apertures. The water inlet apertures are in fluid communication with a water source to receive raw water. The system comprises a shower head conduit in fluid communication with the water inlet apertures and the water outlet apertures. The shower head conduit comprises at least one chemical addition aperture. The system comprises a chemical storage system comprising a chemical reservoir comprising chemical outlet apertures and a chemical conduit. The chemical reservoir is configured to store chemical additive. The chemical conduit is in fluid communication with the chemical outlet apertures and the chemical addition aperture to add chemical additive to the water stream to adjust pH level.

### TECHNICAL FIELD

The present invention generally relates to a plumbing fixture. More specifically, the present invention relates to a shower head system which adjusts the pH of the water passing through it.

### BACKGROUND

Water pH adjustment is a critical process in various applications, including environmental management, industrial processes, and personal care. Traditionally, the focus has been on ensuring water safety and compatibility with human use, which can include adjusting water pH to meet health and safety standards. Technologies in this field range from chemical dosing systems, which add pH-adjusting chemicals to water streams, to more sophisticated systems involving electronic sensors and automated dosing mechanisms.

Various water treatment processes concern adjusting water pH to meet various end-use requirements. Historically, methods to adjust pH have included the use of bulk chemical dosing systems and inline water treatment devices. These systems, while effective to a degree, often lack precision, require significant maintenance, or involve complex installations that are not suitable for all environments, particularly residential settings.

The present invention significantly advances the art of water pH adjustment by introducing a novel shower head system designed to efficiently and accurately modify the pH level of shower water. This system is particularly beneficial for personal care applications, where the adjustment of water pH can have a direct impact on skin and hair health. Municipal water supplies often have a pH level that is not optimal for such applications, typically ranging from slightly alkaline to very alkaline conditions. The inventive system described herein addresses this issue without the complexities and inefficiencies of prior art solutions.

### SUMMARY

The present invention discloses a shower head system. The system comprises a shower head housing comprising a proximal end and a distal end. The proximal end comprises one or more water inlet apertures and the distal end comprises one or more water outlet apertures. The water inlet apertures are in fluid communication with a water source to receive raw water. The system comprises a shower head conduit in fluid communication with the water inlet apertures and the water outlet apertures. The shower head conduit comprises at least one chemical addition aperture. The system comprises a chemical storage system comprising a chemical reservoir comprising chemical outlet apertures and a chemical conduit. The chemical reservoir is configured to store chemical additive. The chemical conduit is in fluid communication with the chemical outlet apertures and the chemical addition aperture to add chemical additive to the water stream to adjust pH level of the water stream and output treated water through the water outlet apertures of the shower head conduit.

In one embodiment, the chemical reservoir comprises chemical cartridge. In another embodiment, the chemical reservoir comprises replaceable chemical cartridge. In one embodiment, the chemical cartridge comprises a transparent surface.

In one embodiment, the system comprises a first coupler assembly comprising a first chemical coupler disposed on the chemical reservoir to connect the chemical outlet apertures of the chemical reservoir, and a second coupler disposed on the chemical conduit. The chemical conduit comprises a chemical inlet aperture. The second coupler is coupled to the first coupler to convey chemical additive from the chemical reservoir to the chemical conduit.

In another embodiment, the system comprises a second coupler assembly comprising a needle disposed at an interior side of the shower head housing. The cartridge comprises a puncture surface. The needle aligns with the puncture surface as the chemical cartridge is inserted into the chemical reservoir. When the chemical cartridge inserted into the chemical reservoir, the needle pierces the puncture surface creating a sealed connection between the chemical cartridge and chemical conduit.

In yet another embodiment, the system further comprises a third coupler assembly comprising a first chemical outlet check valve and a second chemical conduit check valve. The first chemical outlet check valve disposed on the chemical cartridge is configured to seal and unseal a plurality of chemical cartridge apertures.

The second chemical conduit check valve disposed on the chemical reservoir is configured to seal and unseal a plurality of chemical outlet apertures. The first chemical outlet check valve is configured to align with the chemical conduit check valve and fluidically connect the cartridge apertures to the chemical outlet apertures.

In yet another embodiment, the system further comprises a chemical chamber comprises a chamber inlet and chamber outlet. The chemical chamber is in fluid communication with chemical conduit and the chemical cartridge.

In one embodiment, a section of the shower head conduit takes a form of a venturi segment. The venturi segment comprises a section of progressively reducing cross-sectional area, a neck section, and a section of progressively increasing cross-sectional area. The venturi segment creates a Venturi effect to reduce fluid pressure as water flows through the neck section. The Venturi effect produced by the venturi segment draws the chemical additive from the chemical conduit into the water stream in the shower head conduit. In one embodiment, the chemical addition aperture is positioned within the neck section of the venturi segment to maximize the Venturi effect for drawing the chemical additive into the water stream.

In yet another embodiment, the system further comprises a control valve assembly disposed across the chemical conduit. The control valve assembly comprises a control valve having a throttle configured to seal and open the chemical conduit to control the flow of chemical additive through the chemical conduit to adjust the pH level of water.

In one embodiment, the system further comprises a handle connected to the control valve throttle to enable a user to seal and open the chemical conduit. The handle extends to an exterior side of the shower head housing. In one embodiment, the control valve is a needle control valve configured to provide precise control over the flow rate of the chemical additive.

In another embodiment, the system comprises an electronic control system configured to allow a user to adjust the control valve via haptic controls. The haptic controls are selected from a group consisting of a dial, a scrolling wheel, and a button.

In yet another embodiment, the system further comprises one or more pH sensors configured to monitor the pH level of water, and a central processing unit (CPU) in communication with the pH sensors and the control valve. The CPU is configured to automatically adjust the control valve based on the sensed pH level to maintain a target pH range, wherein the CPU is configured to open the control valve to increase the flow rate of chemical additive when the sensed pH is above the target range and close the control valve to restrict the flow rate when the sensed pH is below the target range.

In yet another embodiment, the system further comprises a shut-off valve disposed across the chemical conduit. The shut off valve prevents flow of chemical additive through the chemical conduit.

In yet another embodiment, the system further comprises a pre-filter assembly in fluid communication with the water inlet apertures. The prefilter assembly is configured to remove undesirable contaminants from the water flowing therethrough. In one embodiment, the chemical additive is selected from a group consisting of citric acid, ascorbic acid, phosphoric acid, or a combination thereof. The pre-filter assembly comprises at least one of pre-filter receptacle and pre-filter cartridge comprising filter media.

In another embodiment, the shower head system comprises a shower head housing comprising a proximal end and a distal end. The proximal end comprises one or more water inlet apertures and the distal end comprises one or more water outlet apertures.

The system further comprises a shower head conduit in fluid communication with the water inlet apertures and the water outlet apertures. The system further comprises a chemical storage system comprising a chemical reservoir comprising a chemical cartridge. The water flowing through the shower head housing is directed through the chemical cartridge to reduce the pH level of the water. In one embodiment, the chemical cartridge comprises chemical additive in at least one of solid and gel form.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 shows a front perspective view of the shower head system.

FIG. 2 shows a back perspective view of the shower head system.

FIG. 3 shows a side view of the shower head system.

FIG. 4 shows a side view of the shower head system.

FIG. 5 shows a side sectional view of the shower head system.

FIG. 6 shows a side sectional view of the shower head system.

FIG. 7 shows a side sectional detail view of a first embodiment of the shower head system.

FIG. 8 shows a side sectional detail view of a first embodiment of the shower head system.

FIG. 9 shows a side sectional perspective view of the shower head system.

FIG. 10 shows a side sectional perspective view of second embodiment of the chemical coupling mechanism.

FIG. 11 shows a flow diagram of a third embodiment of the shower head system.

FIG. 12 shows a flow diagram of a fourth embodiment of the shower head system.

FIG. 13 shows a flow diagram of a fifth embodiment of the shower head system.

FIG. 14 shows a flow diagram of a sixth embodiment of the shower head system.

FIG. 15 shows a flow diagram of a seventh embodiment of the shower head system.

FIG. 16 shows a flow diagram of an eighth embodiment of the shower head system.

FIG. 17 shows a flow diagram of a ninth embodiment of the shower head system.

FIG. 18 shows a flow diagram of a tenth embodiment of the shower head system.

FIG. 19 shows a flow diagram of a first illustrated embodiment of the shower head system.

FIG. 20 shows a flow diagram of a second illustrated embodiment of the shower head system.

FIG. 21 shows a flow diagram of a fourteenth embodiment of the shower head system.

FIG. 22 shows a flow diagram of a fifteenth embodiment of the shower head system.

FIG. 23 shows a flow diagram of a sixteenth embodiment of the shower head system.

FIG. 24 shows a flow diagram of an eleventh embodiment of the shower head system.

FIG. 25 shows a flow diagram of a twelfth embodiment of the shower head system.

FIG. 26 shows a flow diagram of a thirteenth embodiment of the shower head system.

### DETAILED DESCRIPTION OF EXAMPLE EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

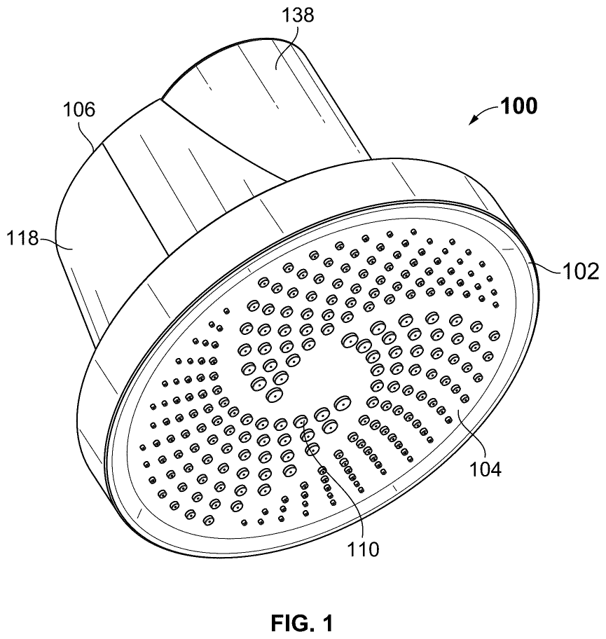

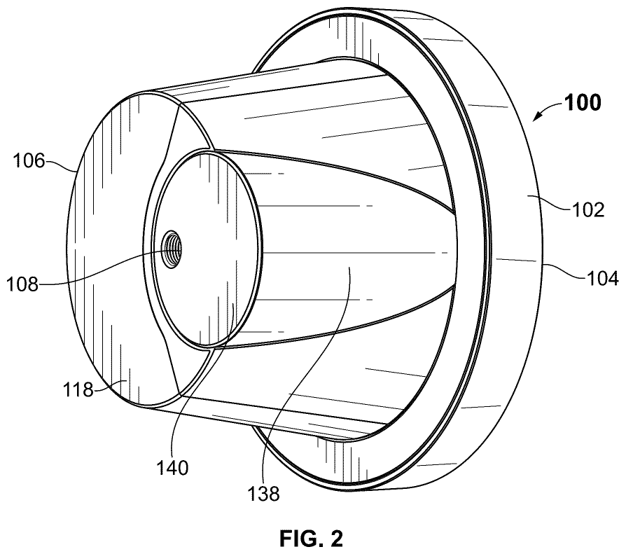

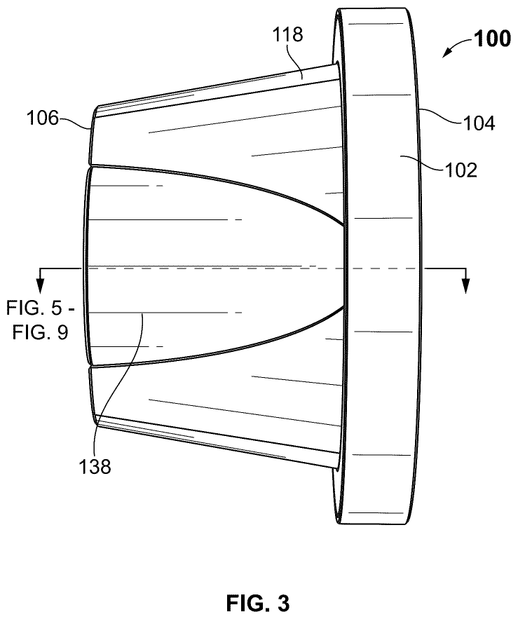

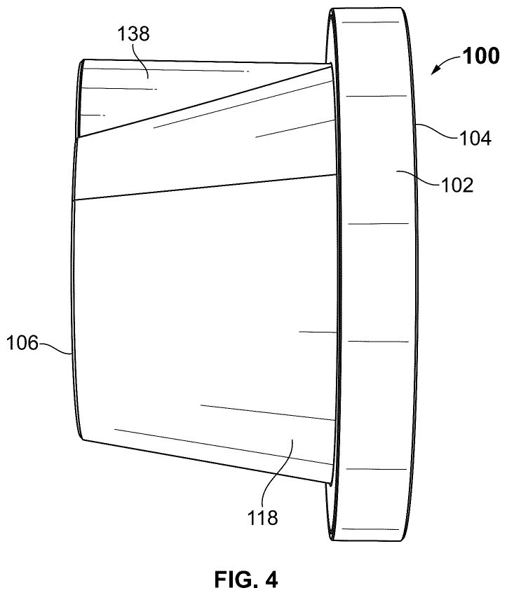

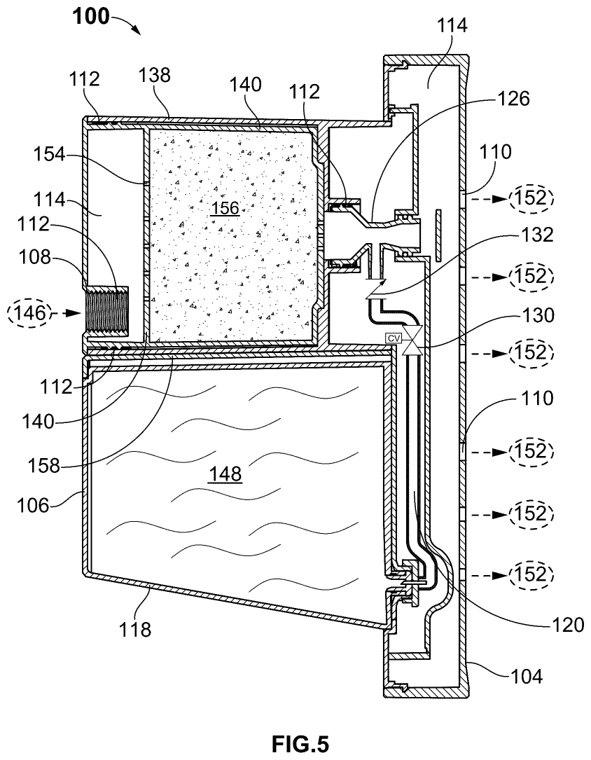

Referring to FIG. 1 to FIG. 4, a shower head system 100 comprises a shower head housing 102 comprising a distal end 104 and a proximal end 106. The distal end 104 comprises one or more water inlet apertures 108 and one or more water outlet apertures 110. In one embodiment, the water inlet apertures 108 comprise plurality of threads 112 on an internal surface of the water inlet apertures 108. The shower head inlet aperture 108 may be coupled to a water source in a variety of ways. In one embodiment, the threaded, shower head inlet aperture 108 is threaded onto a threaded article of shower piping. Water entering the shower head inlet aperture 108 from the water source is referred to as raw water 146 (shown in FIG. 5) herein. Further, water exits the shower head housing 102 through the shower head outlet apertures 110.

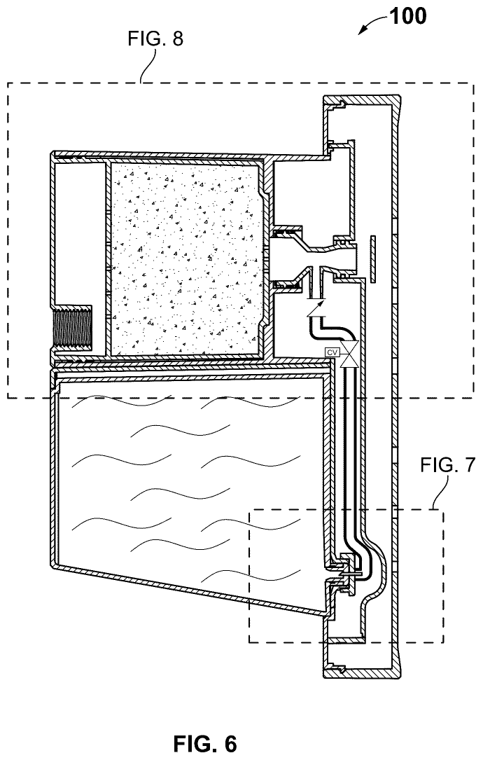

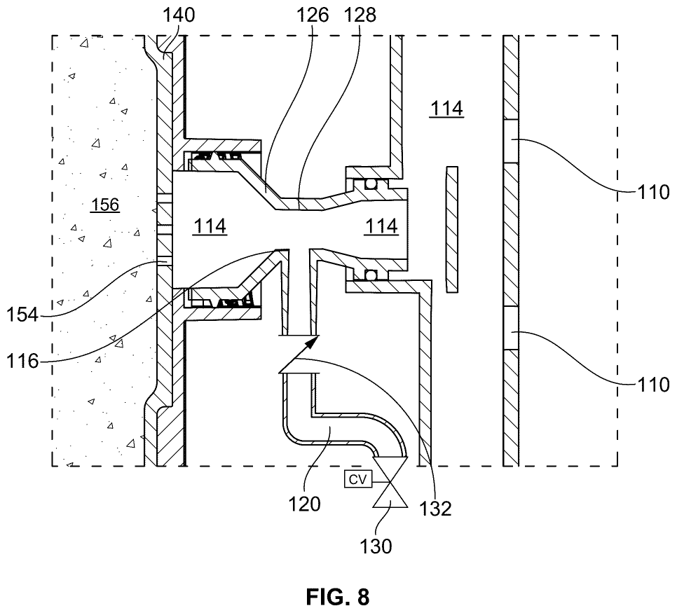

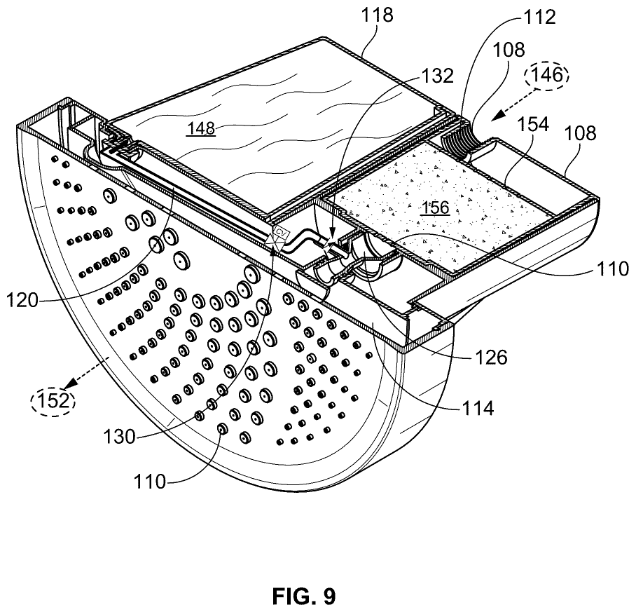

Referring to FIG. 5, FIG. 6 and FIG. 9, the shower head system 100 comprises a shower head conduit 114 in fluid communication with the water inlet apertures 108 and the water outlet apertures 110. In one embodiment, the shower head conduit 114 is formed by a variety of sub-components, which, when assembled together, create a passage way for water to flow through. The shower head conduit 114 has at least one chemical addition aperture 116 (shown in FIG. 8) disposed through a side of the shower head conduit 114.

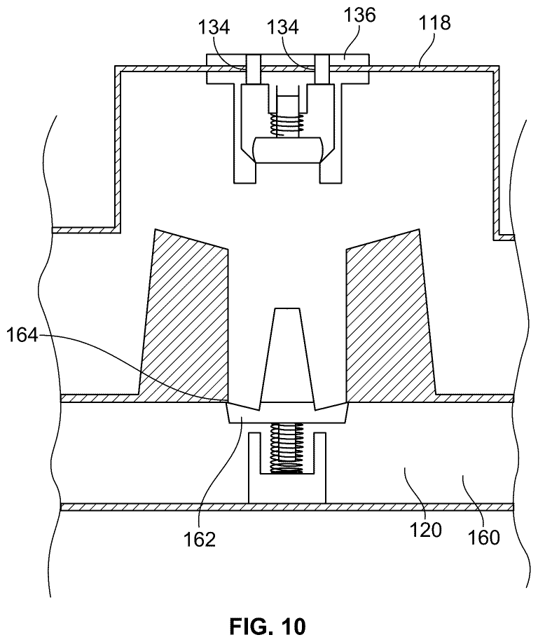

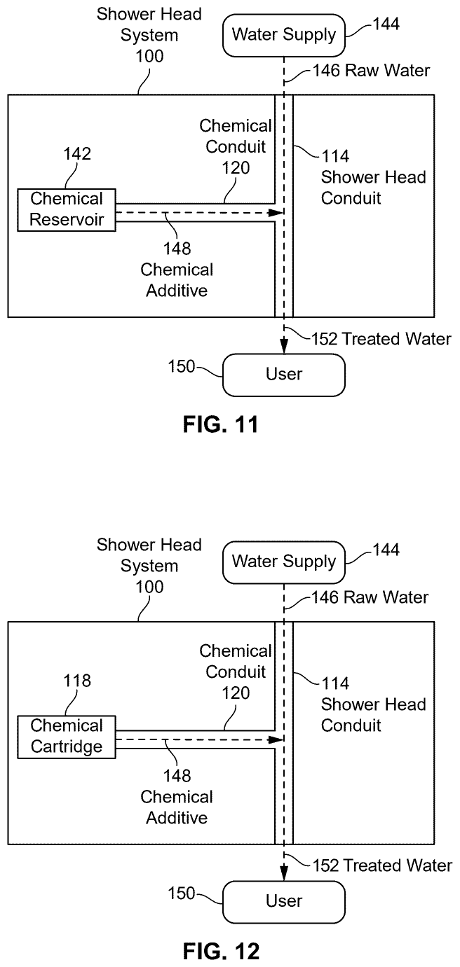

The shower head system 100 comprises a chemical storage system. The chemical storage system stores pH-lowering chemical additive 148 to be added to the water flowing through the shower head conduit 114. In one embodiment, the chemical storage system comprises a chemical reservoir 142 (show in FIG. 11) or chemical receptacle 158. In one embodiment, chemical reservoir 142 comprises a chemical cartridge 118. The chemical storage system further comprises a means for drawing the chemical additive 148 out from the chemical cartridge 118, or chemical reservoir 142 into a chemical conduit 120. In one embodiment, the chemical storage system stores a liquid solution of chemical additive 148. As the shower head system is used, liquid chemical additive 148 is conveyed from the chemical cartridge 118 or chemical reservoir 142 into the shower head conduit 114. When the chemical additive 148 has been consumed, it may be replaced. In one embodiment, the liquid chemical solution is poured into the chemical reservoir 142. However, such a pouring procedure may not be conducive to user safety and ease of operability.

In one embodiment, the chemical cartridge 118 is a replaceable chemical cartridge. When the chemical additive 148 in the chemical cartridge 118 needs to be replenished, a user 150 (shown in FIG. 11) may remove the expended cartridge and replace it with a chemical cartridge 118 containing chemical additive 148. In this way, replenishing the chemical reservoir 142 by replacing an old chemical cartridge 118 with a new chemical cartridge 118 is made safer and simpler.

In another embodiment, the chemical cartridge 118 has transparent surface such that the user 150 may visually see approximately how much chemical additive 148 remains in the chemical cartridge 118. In one embodiment, the shower head system 100 is configured to receive multiple chemical cartridges 118.

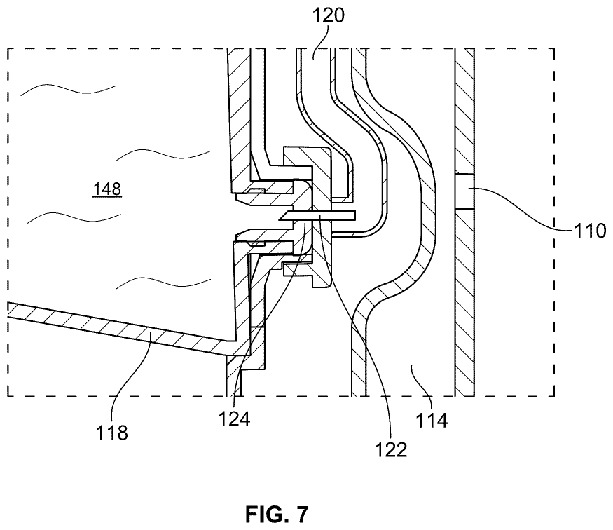

In yet another embodiment, the chemical cartridge 118 is configured with a vent. As chemical additive 148 is conveyed out of the chemical cartridge 118 a small vacuum may form within the chemical cartridge 118. The vacuum is sufficiently minor that the vacuum is relieved by infiltration of air into the chemical cartridge 118, for example and without limitation air may infiltrate into the chemical cartridge 118 through the annular space between a puncture needle 122 and a chemical puncture surface 124 (shown in FIG. 7).

In one embodiment, the shower head system 100 comprises a means for transferring chemical additive 148 from the chemical cartridge 118 to the chemical conduit 120. In another embodiment, the shower head system 100 comprises a first coupler assembly configured to transfer chemical additive 148s. The first coupler assembly comprises a first chemical coupler disposed on the chemical cartridge 118 and a second chemical coupler disposed on the chemical conduit 120 and/or shower head housing 102. When the first and second chemical couplers are coupled together, chemical additive 148 may be conveyed from the chemical cartridge 118 to the chemical conduit 120.

In some simplified embodiments, the chemical cartridge 118 is adapted with a simple chemical outlet aperture, and the chemical conduit 120 is be adapted with a simple chemical inlet aperture. However, because the chemical additive 148 solution is potentially hazardous to a user 150, more sophisticated means for transferring chemical are presented. Embodiments utilizing a chemical coupling mechanism are preferred because they may create a seal between the chemical cartridge 118 and the chemical conduit 120, thereby presenting less risk of an unwanted leak or spill of chemical additive 148.

Referring to FIG. 6 and FIG. 7, in yet another embodiment, the shower head system 100 comprises a second coupler assembly. The second coupler assembly comprises a needle 122 and a puncture surface 124. The chemical cartridge 118 has the puncture surface 124 and the shower head housing 102 have the needle 122. The needle 122 aligns with the puncture surface 124 as the chemical cartridge 118 is inserted into the chemical reservoir 142. As the chemical cartridge 118 inserted into the chemical reservoir 142, the needle 122 pierces the puncture surface 124 creating a sealed connection between the chemical cartridge 118 and chemical reservoir 142.

Referring to FIG. 8, in one embodiment, the chemical additive 148 flows into the shower head conduit 114 through a plurality of chemical addition apertures 116. There are a variety of ways to motivate the flow of chemical additive 148 through the chemical conduit 120 into the shower head conduit 114. In some embodiments, the shower head conduit 114 passes through a venturi segment 126. The Venturi effect is the reduction in fluid pressure that results when a moving fluid speeds up as it flows through a constricted section of the shower head conduit 104. The constricted section of the venturi is referred to as the neck section 128, herein. The venturi segment 126 produces a Venturi effect. In general, the venturi segment 126 is considered part of the shower head conduit 114.

In embodiments having the venturi segment 126, the chemical addition aperture 116 may be disposed through the neck section 128. In other venturi segment 126 embodiments, the chemical aperture may be disposed downstream of the neck section 128. The venturi segment 126 may motivate the flow of chemical additive 148 through the chemical conduit 120 by drawing the chemical additive 148 into the shower head conduit 114 through the chemical addition aperture 116.

In some embodiments, the flow of chemical additive 148 may be motivated by other means. For example, and without limitation, the flow of chemical additive 148 may be produced by gravity, a pump, a pressurized chemical reservoir 142/cartridge 118, a venturi segment 126 as mentioned above, or some combination thereof. However, in the preferred embodiment, flow of chemical additive 148 is motivated by the venturi effect produced by the venturi segment 126 in the shower head conduit 114.

Referring to FIG. 5, FIG. 6 and FIG. 8, in yet another embodiment, the shower head system 100 comprises a control valve 130. In one embodiment, the control valve 130 is manually controlled. In another embodiment, the control valve 130 is adapted with a handle such that when the handle is actuated the control valve throttles open or closed. The handle is accessible to the user 150 from the exterior of the shower head housing 102 such that the user 150 actuates the control valve handle while the shower head system 100 remains assembled and/or installed. In yet another embodiment, the chemical control valve 130 is a needle control valve.

In yet another embodiment, the control valve or chemical control valve 130 is electronically controlled. In electronically controlled embodiments, a user 150 may instruct the control valve 130 to open or close by manipulating haptic controls, for example and without limitation, a dial, a scrolling wheel, or a button. In some electronically controlled embodiments, a pH set point or set point range may be selected by the user 150 or pre-selected by a shower head electronic control system. The shower head system 100 may be further adapted with one or more pH sensors and Central Processing Unit (CPU) control system. In some embodiments, a pH meter may sense the pH of the water downstream of the addition of the chemical additive 148. If the pH meter senses a pH level above the set point or set point range, the CPU control system may instruct the control valve 130 to open throttle to allow a higher flowrate of chemical additive 148, thereby lowering the sensed pH. If the pH meter senses a pH level below the set point or set point range, the control system may instruct the chemical control valve 130 to close throttle to further restrict the flowrate of chemical additive 148, thereby raising the sensed pH.

Referring to FIG. 5, FIG. 6 and FIG. 8, in yet another embodiment, the shower head system 100 comprises a backflow check valve 132. In such embodiments, the chemical backflow check valve 132 is directionally oriented such that chemical may flow through the chemical conduit 120, through the backflow check valve 132, and through the chemical addition aperture 116. In embodiments having a chemical control valve 130, the chemical backflow check valve 132 may be located downstream or upstream of the chemical control valve 130. In preferred embodiments, the chemical backflow check valve 132 is located downstream of the chemical control valve 130. In some embodiments the chemical check may be a diaphragm check valve.

The chemical backflow check valve 132 may prevent water from migrating into the chemical conduit 120. When the flow of water through the shower head system 100 is turned off the venturi effect drawing chemical additive 148 through the chemical addition aperture 116 ceases. When the water is turned off, water remaining in the shower head conduit 114 may migrate from the shower head conduit 114 into the chemical conduit 120. By installing the chemical backflow check valve 132 on the chemical conduit 120, backflow of water from the shower head conduit 114 into the chemical conduit 120 may be mitigated.

In yet another embodiment, the shower head system 100 comprises a shutoff valve. The shut-off valve is disposed on the chemical conduit such that the chemical additive 148 is conveyed through the shut-off valve. When the shut-off is closed, chemical additive 148 is prevented from flowing through the chemical conduit.

Referring to FIG. 10, in yet another embodiment, the shower head system 100 comprises a third coupler assembly. The third coupler assembly is configured to create a seal between the chemical cartridge 118 and the chemical conduit 120. The third coupler assembly comprises one or more check valves. The third coupler assembly comprises a first chemical outlet check valve 136 disposed on the chemical cartridge 118 and a second chemical conduit check valve 162 disposed on the chemical reservoir 142. The first chemical outlet check valve 136 disposed on the chemical cartridge 118 is configured to seal a plurality of chemical cartridge apertures 134. The check valve 162 disposed on the chemical reservoir 142 is configured to seal a plurality of chemical outlet apertures 164. As the chemical cartridge 118 is inserted into the chemical reservoir 142, the cartridge check valve 136 aligns with the chemical conduit check valve 162. As the chemical cartridge 118 is further inserted into the chemical reservoir 142, the cartridge check valve 136 depresses and opens. Similarly, as the chemical cartridge 118 is further inserted into the chemical reservoir 142, chemical outlet check valve 136 depresses and opens. Other embodiments of the check valve mechanism wherein the check valves are not necessarily aligned are contemplated.

In one embodiment, when the chemical additive 148 passes into the chemical conduit 120, the chemical additive 148 enters the chemical conveyance system. The chemical conveyance system comprises at least one chemical conduit 120. In one embodiment, the chemical conduit 120 is formed by a variety of sub-components, which when assembled together, create a passage way for chemical additive 148 solution to flow through. In another embodiment, the chemical conduit 120 is formed from a single component, for example and without limitation, a tube. The amount of chemical additive 148 added to the water stream will, in part, determine the pH of the treated water 152. The chemical conduit 120 may be configured with various means for controlling flowrate and/or the pressure of the chemical additive 148. It may be desirable to be able to more accurately and precisely control the flowrate of chemical additive 148 such that the pH of the treated water 152 may be more accurately and precisely controlled.

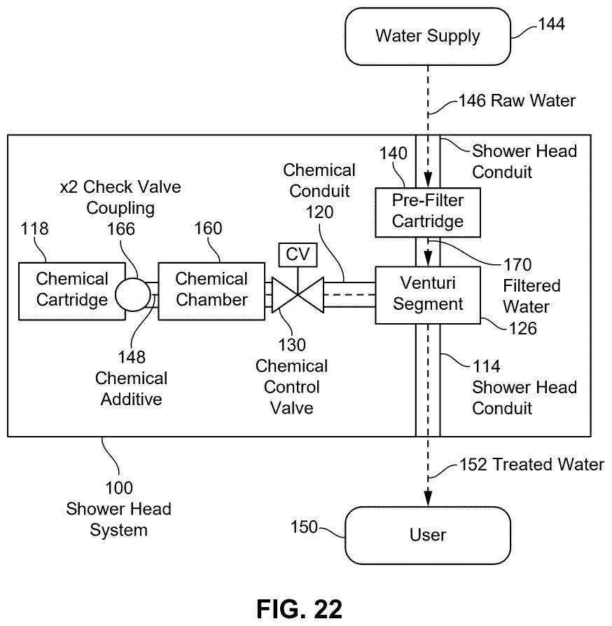

In yet another embodiment, the shower head system 100 comprises a chemical chamber 160 (shown in FIG. 22). The chemical chamber 160 is located on the chemical conduit 120 between the chemical inlet aperture and the chemical addition aperture 116.

Referring to FIG. 10, the chemical chamber 160 has at least one chamber inlet aperture and at least one chamber outlet aperture. Chemical additive 148 flows into the chemical chamber 160 through the chamber inlet aperture. Chemical additive 148 flows out of the chemical chamber 160 through the chamber outlet aperture. In general, the chemical chamber 160 maintains a readily available supply of chemical additive 148 to be conveyed into the shower head conduit 114. Without the chemical chamber 160, the resistance to flow experienced by the chemical additive 148 in the chemical conduit 120 may be higher. The chemical chamber 160 helps to inhibit the formation of bubbles in the chemical conduit 120. Because the chemical chamber 160 has a wider cross-sectional area than other sections of the chemical conduit 120, the wall friction is reduced, thereby reducing the total resistance to flow that the chemical additive 148 experiences due to friction with the chemical conduit 120.

The shower head housing comprises a pre-filter assembly comprising filter media 156. Referring to FIG. 1 to FIG. 5, the pre-filter assembly comprises a pre-filter receptacle 138 having pre-filter apertures 154. In one embodiment, the pre-filter receptacle 138 comprises a pre-filter cartridge 140. In some embodiments, water passing through the shower head conduit 114 may flow through a pre-filter. The pre-filter may remove undesirable contaminants from the water stream. In some embodiments, the pre-filter contains activated carbon. In some embodiments, the pre-filter may be positioned upstream of where the chemical additive 148 enters the shower head conduit 114 such that the water passes through the pre-filter before the pH is reduced. In preferred embodiments incorporating a pre-filter, the pre-filter is a removable and replaceable pre-filter cartridge. In some embodiments, the filter may be configured to introduce minerals into the water stream. For example, and without limitation the pre-filter may release minerals such as calcium, magnesium, and/or potassium.

In some embodiments, pH reduction may be achieved by flowing water through the chemical cartridge 118. This is to say that some or all of the water flowing though the shower head conduit 114 may pass through the chemical cartridge 118. This configuration of chemical addition is called an inline chemical addition embodiment. In an inline chemical addition embodiment, the chemical may not need to be conveyed through the chemical conduit 120, thereby allowing the chemical to take the form of a solid or a gel. In some inline chemical addition embodiments, the chemical additive 148 may be replenished by refiling the chemical reservoir 142 with chemical additive 148. In preferred inline chemical addition embodiments, the chemical additive 148 is stored within a chemical cartridge 118, and the chemical cartridge 118 is inserted into the chemical reservoir 142. As the chemical additive 148 is consumed by the flowing water the chemical cartridge 118 may be removed and replaced with a chemical cartridge 118 containing chemical additive 148.

There are various chemical compounds that can lower the pH of water. These pH-lowering chemical compounds, and the solution or media they are contained within, are called chemical additive 148s herein. For example, some chemical additive 148s may comprise citric acid, ascorbic acid, phosphoric acid, or some combination thereof. In some embodiments, the chemical additive 148 may be a liquid solution containing citric acid. In some embodiments, a citric acid solution may utilize food grade citrus acid. Liquid chemical additive 148s are generally used in embodiments where the chemical additive 148 is conveyed to the water stream from a chemical cartridge 118 or reservoir through a chemical conduit 120.

In some embodiments, a non-liquid chemical additive 148 may be used. For example, and without limitation, in some inline chemical addition embodiments the chemical additive 148 may be in a solid and/or gel form. In some embodiments, the chemical additive 148 may be infused within beads. In other embodiments, the chemical additive 148 may be infused within a mineral block substance. As the water stream washes through the solid and/or gel chemical additive 148, the chemical additive 148 is dissolved into the water stream, thereby lowering the pH of the treated water 152.

Referring to FIG. 11, the shower head system 100 incorporates the chemical reservoir 142. Water from the water supply 144 enters as raw water 146 into the shower head inlet aperture 108. The system 100 equipped with the shower head conduit 114 directs the flow of water through the shower head system 100. Alongside, the separate chemical conduit 120 is connected to the chemical reservoir 142, which holds a pH-lowering additive 148. As water flows through the shower head conduit 114, the chemical additive 148 is introduced into the stream via the chemical conduit 120. This combination yields treated water 152 that exits through the shower head outlet apertures 110, now adjusted for pH, and reaches the user 150.

Referring to FIG. 12, the shower head system 100 incorporates the chemical cartridge 118. Water from the water supply 144 enters as raw water 146 into the shower head inlet aperture 108. The system 100 equipped with the shower head conduit 114 directs the flow of water through the shower head system 100. Alongside, the separate chemical conduit 120 is connected to the chemical cartridge 118, which holds a pH-lowering additive 148. As water flows through the shower head conduit 114, the chemical additive 148 is introduced into the stream via the chemical conduit 120. This combination yields treated water 152 that exits through the shower head outlet apertures 110, now adjusted for pH, and reaches the user 150.

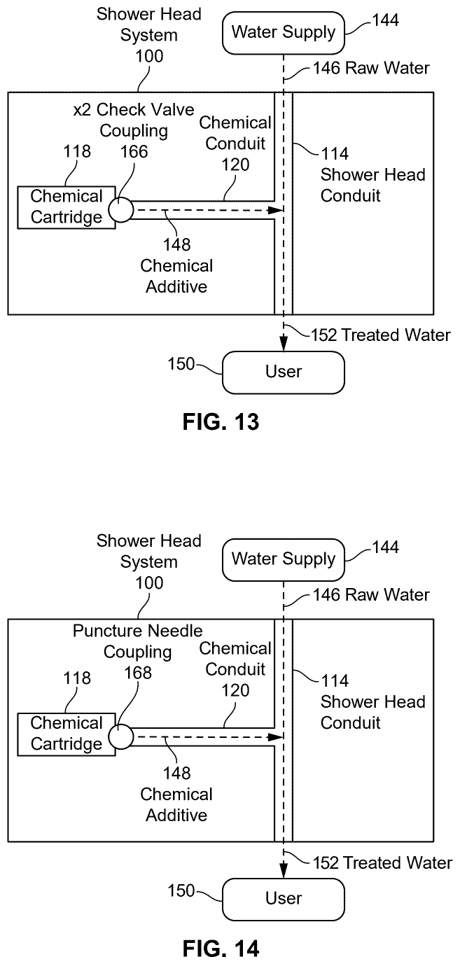

Referring to FIG. 13, in one embodiment, the system 100 integrates a two-check valve coupling 166 to ensure safe and controlled chemical transfer between the chemical cartridge 118 and chemical conduit 120. The chemical cartridge 118 and the chemical conduit 120 are each equipped with check valves. As the chemical cartridge 118 is inserted, the check valves align and depress, creating an open pathway for the chemical additive 148. The two-check valve couplings 166 prevents accidental leaks or spills by maintaining a sealed environment until both check valves couplings 166 are fully engaged.

Referring to FIG. 14, in another embodiment, the system 100 comprises a puncture needle coupling 168. The puncture needle coupling 168 includes the puncture needle 122 and the puncture surface 124 of the chemical cartridge 118. When the chemical cartridge 118 is inserted, the needle 122 pierces the puncture surface 124, establishing a sealed pathway for the additive 148 to enter the chemical conduit 120. This design minimizes leakage risk and ensures that the additive 148 can only flow once the chemical cartridge 118 and chemical conduit 120 are securely coupled.

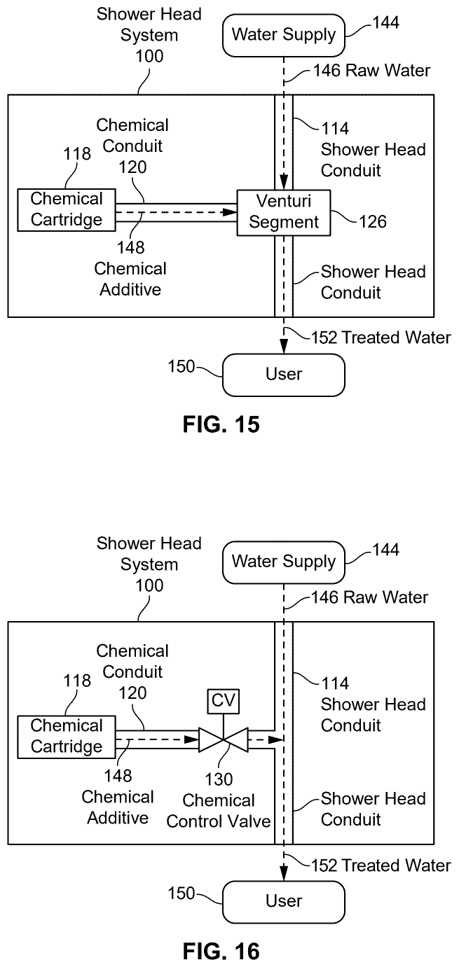

Referring to FIG. 15, the shower head system 100 comprises the chemical cartridge 118, the chemical conduit 120 in fluid communication with the chemical cartridge 118, and the shower head conduit 114 in fluid communication with the chemical conduit 120. The shower head conduit 114 is in fluid communication with the water inlet apertures 108 and the water outlet apertures 110. The water inlet apertures 108 are coupled to the water supply 144 to receive raw water 146. The user 150 receives treated water 152 via the water outlet apertures 110. The system 100 further comprises the venturi segment 126 in fluid communication with the chemical conduit 120 and chemical cartridge 118.

The venturi segment 126 is configured to create a controlled suction effect. As raw water 146 flows through the neck section 128 (the narrowest part of the venturi), the flow speeds up, reducing the pressure and drawing the chemical additive 148 from the chemical conduit 120 into the water stream. The resulting treated water 152 exits the shower head system 100 with an adjusted pH. This venturi effect provides a natural and efficient way to introduce the additive 148 without additional pumps or complex mechanisms.

Referring to FIG. 16, the shower head system 100 comprises the chemical cartridge 118, the chemical conduit 120 in fluid communication with the chemical cartridge 118, and the shower head conduit 114 in fluid communication with the chemical conduit 120. The shower head conduit 114 is in fluid communication with the water inlet apertures 108 and the water outlet apertures 110. The water inlet apertures 108 are coupled to the water supply 144 to receive raw water 146. The user 150 receives treated water 152 via the water outlet apertures 110. The system 100 further comprises the chemical control valve 130 disposed across the chemical conduit 120. The chemical control valve 130 on the chemical conduit 120 regulates the flow rate of the chemical additive 148. The control valve 130, which may be manually or electronically operated, allows users 150 to adjust the additive 148's concentration in the treated water. By increasing or decreasing the flow rate of the additive 148, users 150 can fine-tune the pH adjustment according to their preferences or requirements, providing a customized showering experience.

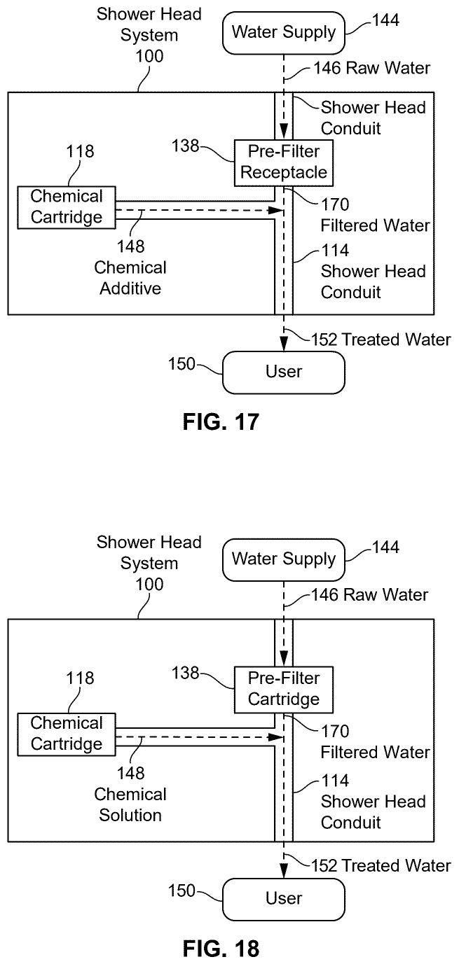

Referring to FIG. 17, the shower head system 100 comprises the chemical cartridge 118, the chemical conduit 120 in fluid communication with the chemical cartridge 118, and the shower head conduit 114 in fluid communication with the chemical conduit 120. The shower head conduit 114 is in fluid communication with the water inlet apertures 108 and the water outlet apertures 110. The water inlet apertures 108 are coupled to the water supply 144 to receive raw water 146. The system further comprises the pre-filter receptacle 138 adjacent to the water inlet apertures 108. The user 150 receives treated water 152 via the water outlet apertures 110.

The raw water 146 first passes through the pre-filter receptacle 138, which removes impurities and contaminants before entering the shower head conduit 114 for pH adjustment. The filtered water 170 then flows through the chemical conduit 120, where the pH-lowering additive 148 is introduced. This configuration improves the water quality by ensuring the water is filtered before pH adjustment.

Referring to FIG. 18, the shower head system 100 comprises the chemical cartridge 118, the chemical conduit 120 in fluid communication with the chemical cartridge 118, and the shower head conduit 114 in fluid communication with the chemical conduit 120. The shower head conduit 114 is in fluid communication with the water inlet apertures 108 and the water outlet apertures 110. The water inlet apertures 108 are coupled to the water supply 144 to receive raw water 146. The system further comprises the pre-filter cartridge 140 adjacent to the water inlet apertures 108. The user 150 receives treated water 152 via the water outlet apertures 110.

The raw water 146 first passes through the pre-filter cartridge 140, which removes impurities and contaminants before entering the shower head conduit 114 for pH adjustment. The filtered water 170 then flows through the chemical conduit 120, where the pH-lowering additive 148 is introduced. This configuration improves the water quality by ensuring the water is filtered before pH adjustment.

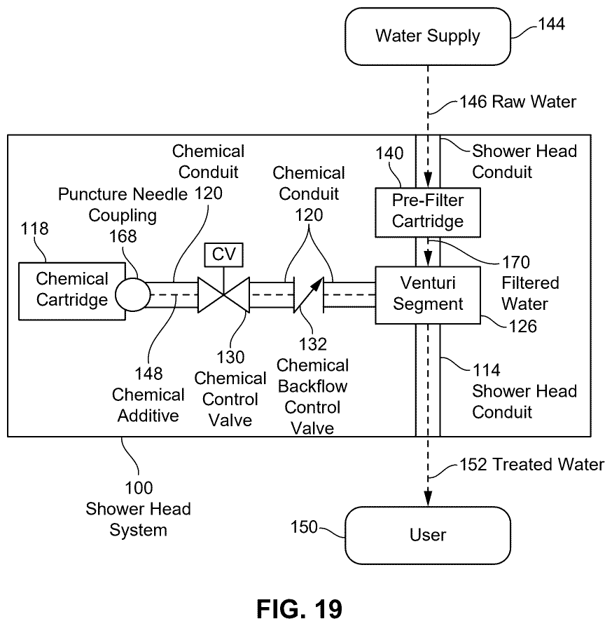

Referring to FIG. 19, the shower head system 100 comprises the chemical cartridge 118, the chemical conduit 120 in fluid communication with the chemical cartridge 118, and the shower head conduit 114 in fluid communication with the chemical conduit 120. The shower head conduit 114 is in fluid communication with the water inlet apertures 108 and the water outlet apertures 110. The water inlet apertures 108 are coupled to the water supply 144 to receive raw water 146. The system further comprises the pre-filter cartridge 140 adjacent to the water inlet apertures 108. The raw water 146 passes through the pre-filter cartridge 140 to remove impurities before entering the venturi segment 126 disposed adjacent to the pre-filter cartridge 140.

The chemical cartridge 118 is in fluid communication with the venturi segment 126 via the chemical conduit 120. The system 100 further comprises the puncture needle coupling 168 fluidically connecting the chemical cartridge 118 with the chemical conduit 120. The system 100 further comprises the chemical control valve 130 disposed across the chemical conduit 120 adjacent to the puncture needle coupling 168. The system 100 further comprises the chemical backflow control valve 132 disposed across the chemical conduit 120 adjacent to the chemical control valve 130.

The raw water 146 flows into the pre-filter cartridge 140, where impurities are removed. The filtered water 170 then passes through the venturi segment 126, creating suction that draws the chemical additive 148 through the chemical conduit 120 via the puncture needle coupling 168, the chemical control valve 130 and the chemical backflow control valve 132. The chemical backflow control valve 132 on the chemical conduit 120 prevents reverse flow, ensuring the chemical additive 148 only enters the shower head conduit 114 when needed. Thereafter, the user 150 receives treated water 152 via the water outlet apertures 110.

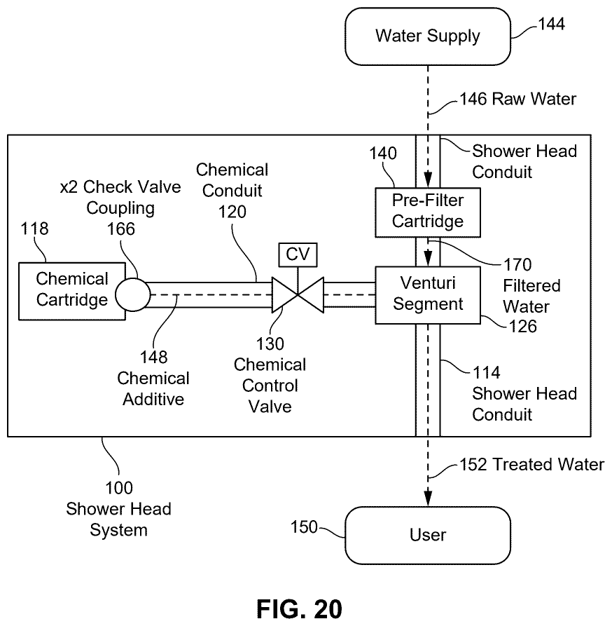

Referring to FIG. 20, the shower head system 100 comprises the chemical cartridge 118, the chemical conduit 120 in fluid communication with the chemical cartridge 118, and the shower head conduit 114 in fluid communication with the chemical conduit 120. The shower head conduit 114 is in fluid communication with the water inlet apertures 108 and the water outlet apertures 110. The water inlet apertures 108 are coupled to the water supply 144 to receive raw water 146. The system further comprises the pre-filter cartridge 140 adjacent to the water inlet apertures 108. The raw water 146 passes through the pre-filter cartridge 140 to remove impurities before entering the venturi segment 126 disposed adjacent to the pre-filter cartridge 140.

The chemical cartridge 118 is in fluid communication with the venturi segment 126 via the chemical conduit 120. The system 100 further comprises the puncture needle coupling 168 fluidically connecting the chemical cartridge 118 with the chemical conduit 120. The system 100 further comprises the chemical control valve 130 disposed across the chemical conduit 120 adjacent to the puncture needle coupling 168.

The raw water 146 flows into the pre-filter cartridge 140, where impurities are removed. The filtered water 170 then passes through the venturi segment 126, creating suction that draws the chemical additive 148 through the chemical conduit 120 via the puncture needle coupling 168, and the chemical control valve 130. Thereafter, the user 150 receives treated water 152 via the water outlet apertures 110.

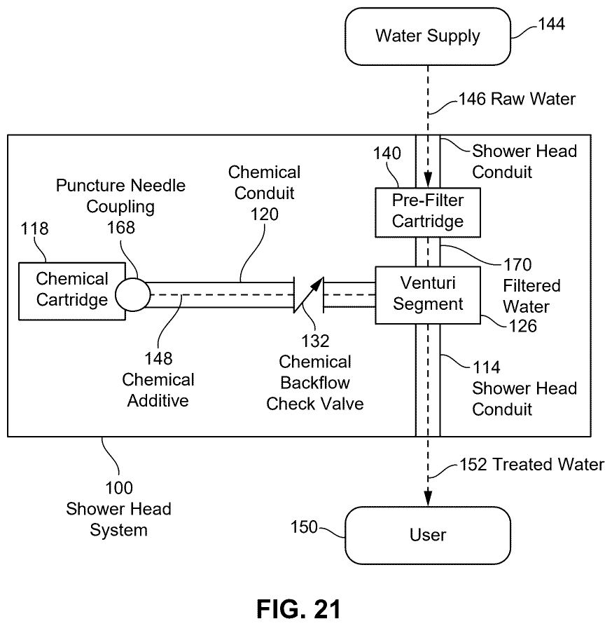

Referring to FIG. 21, the shower head system 100 comprises the chemical cartridge 118, the chemical conduit 120 in fluid communication with the chemical cartridge 118, and the shower head conduit 114 in fluid communication with the chemical conduit 120. The shower head conduit 114 is in fluid communication with the water inlet apertures 108 and the water outlet apertures 110. The water inlet apertures 108 are coupled to the water supply 144 to receive raw water 146. The system further comprises the pre-filter cartridge 140 adjacent to the water inlet apertures 108. The raw water 146 passes through the pre-filter cartridge 140 to remove impurities before entering the venturi segment 126 disposed adjacent to the pre-filter cartridge 140.

The chemical cartridge 118 is in fluid communication with the venturi segment 126 via the chemical conduit 120. The system 100 further comprises the puncture needle coupling 168 fluidically connecting the chemical cartridge 118 with the chemical conduit 120. The system 100 further comprises the chemical backflow control valve 132 disposed across the chemical conduit 120 adjacent to the puncture needle coupling 168.

The raw water 146 flows into the pre-filter cartridge 140, where impurities are removed. The filtered water 170 then passes through the venturi segment 126, creating suction that draws the chemical additive 148 through the chemical conduit 120 via the puncture needle coupling 168, and the chemical backflow control valve 132. The chemical backflow control valve 132 on the chemical conduit 120 prevents reverse flow, ensuring the chemical additive 148 only enters the shower head conduit 114 when needed. Thereafter, the user 150 receives treated water 152 via the water outlet apertures 110.

Referring to FIG. 22, the shower head system 100 comprises the chemical cartridge 118, the chemical conduit 120 in fluid communication with the chemical cartridge 118, and the shower head conduit 114 in fluid communication with the chemical conduit 120. The shower head conduit 114 is in fluid communication with the water inlet apertures 108 and the water outlet apertures 110. The water inlet apertures 108 are coupled to the water supply 144 to receive raw water 146. The system further comprises the pre-filter cartridge 140 adjacent to the water inlet apertures 108. The raw water 146 passes through the pre-filter cartridge 140 to remove impurities before entering the venturi segment 126 disposed adjacent to the pre-filter cartridge 140.

The chemical cartridge 118 is in fluid communication with the venturi segment 126 via the chemical conduit 120. The system 100 further comprises two check valve coupling 166 fluidically connecting the chemical cartridge 118 with the chemical conduit 120. The system 100 further comprises the chemical chamber 160 disposed across the chemical conduit 120 and adjacent to the check valve coupling 166. The system 100 further comprises the chemical control valve 130 disposed across the chemical conduit 120 adjacent to the chemical chamber 160.

The raw water 146 flows into the pre-filter cartridge 140, where impurities are removed. The filtered water 170 then passes through the venturi segment 126, creating suction that draws the chemical additive 148 through the chemical conduit 120 via the two check valve coupling 166, the chemical chamber 160 and the chemical control valve 130. The chemical chamber 160 stores a ready supply of additive 148 and helps to control flow resistance. The chemical chamber 160 has wider cross-sectional area, which reduces friction and allows for smoother and more controlled flow of the chemical additive 148 into the water stream. Thereafter, the user 150 receives treated water 152 via the water outlet apertures 110.

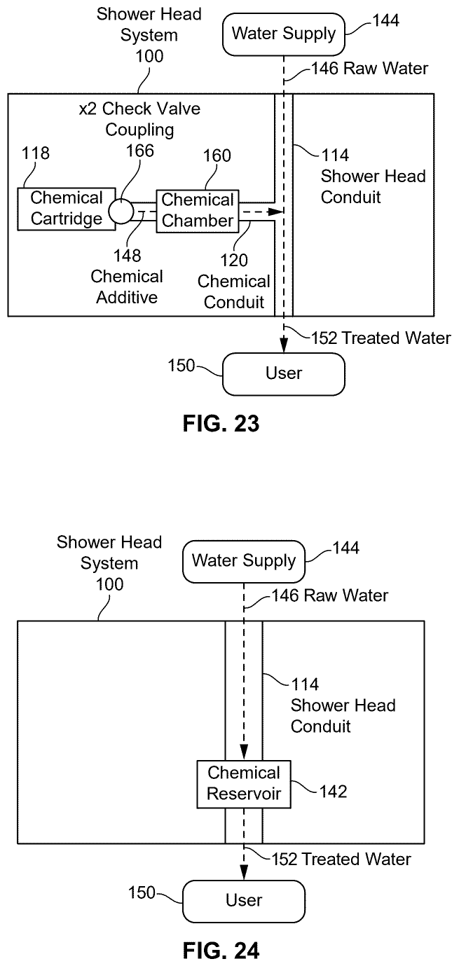

Referring to FIG. 23, the shower head system 100 comprises the chemical cartridge 118, the chemical conduit 120 in fluid communication with the chemical cartridge 118, and the shower head conduit 114 in fluid communication with the chemical conduit 120. The shower head conduit 114 is in fluid communication with the water inlet apertures 108 and the water outlet apertures 110. The water inlet apertures 108 are coupled to the water supply 144 to receive raw water 146. The user 150 receives treated water 152 via the water outlet apertures 110.

The system 100 further comprises two check valve couplings 166 coupling the chemical cartridge 118 to the chemical conduit 120. The system 100 further comprises the chemical chamber 160 disposed in fluid communication with the check valve couplings 166 and the chemical conduit 120.

As the chemical cartridge 118 is inserted, the check valve couplings 166 open, allowing the additive 148 to flow into the chemical chamber 160. The chemical chamber 160 stores a portion of the additive 148, helping to regulate the flow and maintain a steady introduction of the additive 148 into the shower head conduit 144. Thereafter, the user 150 receives treated water 152 via the water outlet apertures 110.

Referring to FIG. 24, the shower head system 100 comprises the chemical reservoir 142 and the shower head conduit 114 in fluid communication with the water inlet apertures 108 and the water outlet apertures 110. The chemical reservoir 142 is disposed across the shower head conduit 114. The system 100 enables an inline chemical addition setup where raw water 146 flows directly through a chemical reservoir 142. As raw water 146 passes through the chemical reservoir 142, the chemical additive 148 dissolves directly into the stream, allowing for a simplified and more direct pH adjustment. This setup eliminates the need for a separate chemical conduit. Thereafter, the user 150 receives treated water 152 via the water outlet apertures 110.

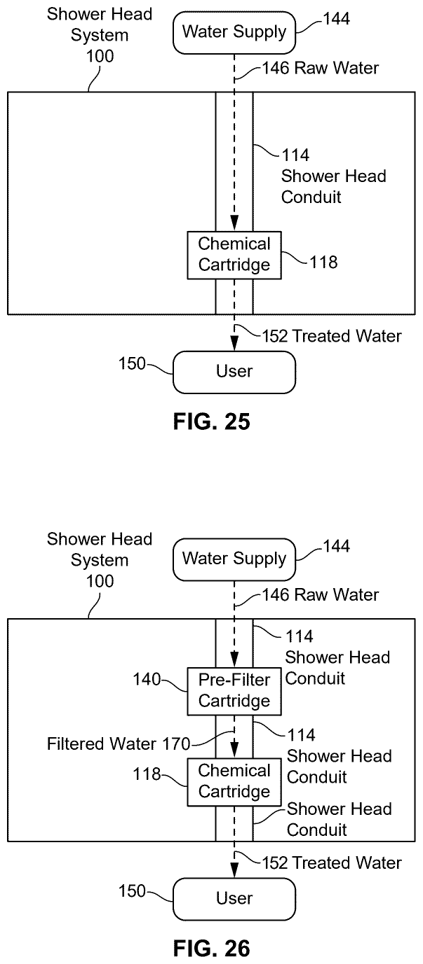

Referring to FIG. 25, the shower head system 100 comprises the chemical cartridge 120 and the shower head conduit 114 in fluid communication with the water inlet apertures 108 and the water outlet apertures 110. The chemical cartridge 120 is disposed across the shower head conduit 114. The system 100 enables an inline chemical addition setup where raw water 146 flows directly through a chemical cartridge 120. As raw water 146 passes through the chemical cartridge 120, the chemical additive 148 dissolves directly into the stream, allowing for a simplified and more direct pH adjustment. This setup eliminates the need for a separate chemical conduit. Thereafter, the user 150 receives treated water 152 via the water outlet apertures 110.

Referring to FIG. 26, the shower head system 100 comprises the chemical cartridge 120 and the shower head conduit 114 in fluid communication with the water inlet apertures 108 and the water outlet apertures 110. The user 150 receives treated water 152 via the water outlet apertures 110. The chemical cartridge 120 is disposed across the shower head conduit 114. The system 100 further comprises the pre-filter receptacle 138 adjacent to the water inlet apertures 108.

The raw water 146 first passes through the pre-filter receptacle 138, which removes impurities and contaminants before entering the shower head conduit 114 for pH adjustment. The filtered water 170 then flows through the chemical cartridge 120, where the pH-lowering additive 148 is introduced. This configuration improves the water quality by ensuring the water is filtered before pH adjustment. Thereafter, the user 150 receives treated water 152 via the water outlet apertures 110.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A shower head system, comprising:
a shower head housing comprising a proximal end and a distal end, wherein the proximal end comprises one or more water inlet apertures and the distal end comprises one or more water outlet apertures, wherein the water inlet apertures are in fluid communication with a water source to receive water and the water outlet apertures configured to dispense treated water;
a shower head conduit in fluid communication with the water inlet apertures and the water outlet apertures, wherein the shower head conduit comprises at least one chemical addition aperture for introduction of a chemical additive into a water stream flowing through the shower head conduit, and
a chemical storage system comprising a chemical reservoir comprising one or more chemical outlet apertures and a chemical conduit, wherein the chemical reservoir is configured to store chemical additive and wherein the chemical conduit is in fluid communication with the chemical outlet apertures and the chemical addition aperture to add chemical additive to the water stream to adjust pH level of the water stream and output treated water through the water outlet apertures of the shower head conduit.

2. The shower head system of claim 1, wherein the chemical reservoir comprises a chemical cartridge.

3. The shower head system of claim 2, wherein the chemical reservoir comprises a replaceable chemical cartridge.

4. The shower head system of claim 3, wherein the chemical cartridge comprises a transparent surface.

5. The shower head system of claim 1, further comprising a first coupler assembly comprising:
a first chemical coupler disposed on the chemical reservoir to connect the chemical outlet apertures of the chemical reservoir, and
a second chemical coupler disposed on the chemical conduit, wherein the chemical conduit comprises a chemical inlet aperture, wherein the second coupler is coupled to the first coupler to convey chemical additive from the chemical reservoir to the chemical conduit.

6. The shower head system of claim 4, further comprising a second coupler assembly comprising:
a needle disposed at an interior side of the shower head housing, and
the chemical cartridge comprises a puncture surface, wherein the needle aligns with the puncture surface as the chemical cartridge is inserted into the chemical reservoir, wherein, when the chemical cartridge is inserted into the chemical reservoir, the needle pierces the puncture surface creating a sealed connection between the chemical cartridge and chemical conduit.

7. The shower head system of claim 4, further comprising a third coupler assembly comprising:
a first chemical outlet check valve disposed on the chemical cartridge configured to seal and unseal a plurality of chemical cartridge apertures, and
a second chemical conduit check valve disposed on the chemical reservoir configured to seal and unseal a plurality of chemical outlet apertures,
wherein the first chemical outlet check valve is configured to align with the chemical conduit check valve and fluidically connect the cartridge apertures to the chemical outlet apertures.

8. The shower head system of claim 4, further comprising a chemical chamber comprises a chamber inlet and chamber outlet, wherein the chemical chamber is in fluid communication with the chemical conduit and the chemical cartridge.

9. The shower head system of claim 1, wherein a section of the shower head conduit takes a form of a venturi segment, wherein the venturi segment comprising a section of progressively reducing cross-sectional area, a neck section, and a section of progressively increasing cross-sectional area, wherein the venturi segment creates a Venturi effect to reduce fluid pressure as water flows through the neck section, wherein the Venturi effect produced by the venturi segment draws the chemical additive from the chemical conduit into the water stream in the shower head conduit.

10. The shower head system of claim 9, wherein the chemical addition aperture is positioned within the neck section of the venturi segment to maximize the Venturi effect for drawing the chemical additive into the water stream.

11. The shower head system of claim 1, further comprising a control valve assembly disposed across the chemical conduit, wherein the control valve assembly comprises a control valve having a throttle configured to seal and open the chemical conduit to control a flow of chemical additive through the chemical conduit to adjust a pH level of water.

12. The shower head system of claim 11, further comprising a handle connected to the control valve throttle to enable a user to seal and open the chemical conduit, wherein the handle extends to an exterior side of the shower head housing.

13. The shower head system of claim 11, further comprising an electronic control system configured to allow a user to adjust the control valve via haptic controls, wherein the haptic controls are selected from a group consisting of a dial, a scrolling wheel, and a button.

14. The shower head system of claim 11, further comprising:
one or more pH sensors configured to monitor the pH level of water, and a central processing unit (CPU) in communication with the pH sensors and the control valve, configured to automatically adjust the control valve based on the sensed pH level to maintain a target pH range, wherein the CPU is configured to open the control valve to increase the flow rate of chemical additive when the sensed pH is above the target range and close the control valve to restrict the flow rate when the sensed pH is below the target range.

15. The shower head system of claim 1, further comprising a shut-off valve disposed across the chemical conduit, wherein the shut off valve prevents flow of chemical additive through the chemical conduit.

16. The shower head system of claim 1, further comprising a chemical backflow control valve in fluid communication with the chemical conduit and shower head conduit, wherein the chemical backflow control valve is configured to allow the chemical additive to flow through the chemical conduit toward the shower head conduit, while preventing backflow of water from the shower head conduit into the chemical conduit.

17. The shower head system of claim 1, further comprising a pre-filter assembly in fluid communication with the water inlet apertures and shower head conduit, wherein the prefilter assembly is configured to remove undesirable contaminants from the water flowing therethrough and supply filtered water to the shower head conduit, wherein the pre-filter assembly comprises at least one of a pre-filter receptacle and a pre-filter cartridge comprising filter media.

18. The shower head system of claim 1, wherein the chemical additive is selected from a group consisting of citric acid, ascorbic acid, phosphoric acid, or a combination thereof.

19. A shower head system, comprising:
a shower head housing comprising a proximal end and a distal end, wherein the proximal end comprises one or more water inlet apertures and the distal end comprises one or more water outlet apertures, wherein the water inlet apertures are in fluid communication with a water source to receive water and the water outlet apertures configured to dispense treated water;
a shower head conduit in fluid communication with the water inlet apertures and the water outlet apertures, and
a chemical storage system comprising a chemical reservoir comprising a chemical cartridge, wherein the chemical reservoir is in fluid communication with the shower head conduit, wherein the water flowing through the shower head housing is directed through the chemical cartridge to reduce the pH level of the water and output treated water through the water outlet apertures.

20. The shower head system of claim 19, further comprises:
a pre-filter assembly in fluid communication with the water inlet apertures and shower head conduit, wherein the prefilter assembly is configured to remove undesirable contaminants from the water flowing therethrough and supply filtered water to the shower head conduit, wherein the pre-filter assembly comprises at least one of a pre-filter receptacle and a pre-filter cartridge comprising filter media, and wherein the chemical cartridge comprises chemical additive in at least one of solid and gel form.
